(19) United States
(12) Patent Application Publication
(10) Pub. No.: US 2026/0136417 A1
(43) Pub. Date: May 14, 2026

(54) TECHNIQUES TO MANAGE BEARER INDEPENDENT PROTOCOL (BIP) MESSAGES FOR PROTOCOL FAILURES

(71) Applicant: Apple Inc., Cupertino, CA (US)

(72) Inventors: Nitin KUPPELUR, Bangalore (IN); Chandra Kiran Raju MANDAPATI, Bangalore (IN); Deepak DASH, Bangalore (IN); Hyewon LEE, Cupertino, CA (US); Stanley M. MAYALIL, San Jose, CA (US); Vivek G. GUPTA, San Jose, CA (US); Xiangying YANG, Cupertino, CA (US)

(21) Appl. No.: 19/364,837

(22) Filed: Oct. 21, 2025

(30) Foreign Application Priority Data
Nov. 12, 2024 (IN) 202411087296
Jan. 30, 2025 (IN) 202511007733

(51) Int. Cl. H04W 76/15; H04W 12/08; H04W 12/72

(52) U.S. Cl. CPC H04W 76/15; H04W 12/08; H04W 12/72

(57) ABSTRACT

The described embodiments regard methods and apparatus for managing bearer independent protocol (BIP) message communication responsive to protocol failures, including during session management procedures to establish a data connection with a wireless network. A network entity rejects establishment of a data communication based on a parameter incompatibility, capabilities, and/or operating conditions of the wireless network. A BIP response message to a secure element that initiates establishment of the data connection can include an indication of cause for the rejection, an indication of whether the rejection is temporary or permanent, and a backoff time indication for a temporary rejection.

### CROSS-REFERENCE TO RELATED APPLICATIONS

The present application claims priority to India Application No. 202511007733,entitled “TECHNIQUES TO MANAGE BEARER INDEPENDENT PROTOCOL (BIP) MESSAGES FOR PROTOCOL FAILURES,” filed Jan. 30, 2025 and India Application No. 202411087296, entitled “TECHNIQUES TO MANAGE BEARER INDEPENDENT PROTOCOL (BIP) MESSAGES FOR PROTOCOL FAILURES,” filed Nov. 12, 2024, the contents of all of which are incorporated by reference herein in their entirety for all purposes.

### FIELD

The described embodiments relate to wireless communications, including methods and apparatus to manage bearer independent protocol (BIP) message communication at a wireless device responsive to protocol failures, such as during session management procedures to establish a data connection with a cellular wireless network.

### BACKGROUND

Newer generation, fifth generation (5G), cellular wireless networks that implement one or more 3^{rd} Generation Partnership Project (3GPP) standards are rapidly being developed and deployed by mobile network operators (MNOs) worldwide. In addition, sixth generation (6G) standards are in active development. The newer cellular wireless networks provide a range of packet-based services, with 5G (and 6G) technology providing increased data throughput and lower latency connections that promise enhanced mobile broadband services for 5G-capable (and 6G-capable) wireless devices. Access to cellular services provided by an MNO can require use to cellular credentials and/or secure processing provided by a secure element (SE), such as a universal integrated circuit card (UICC), an embedded UICC (eUICC), or an integrated UICC (iUICC) included in the wireless device.

Typically, wireless devices have been configured to use removable UICCs, that include at least a microprocessor and a read-only memory (ROM), where the ROM is configured to store an MNO profile, also referred to as subscriber identity module (SIM) or SIM profile, which the wireless device can use to register and interact with an MNO to obtain wireless services via a cellular wireless network. The SIM profile hosts subscriber data, such as a digital identity and one or more cryptographic keys, to allow the wireless device to communicate with a cellular wireless network. Typically, a UICC takes the form of a small removable card, commonly referred to as a SIM card or physical SIM (pSIM) card, which can be inserted into a UICC-receiving bay of a mobile wireless device. In more recent implementations, UICCs are being embedded directly into system boards of wireless devices as eUICCs or integrated with other system components as iUICCs, which can provide advantages over traditional, removable UICCs. The eUICCs and/or iUICCs can include a rewritable memory that can facilitate installation, modification, and/or deletion of one or more electronic SIMs (eSIMs) on the eUICC/iUICC, where the eSIMs can provide for new and/or different services and/or updates for accessing extended features provided by MNOs. An eUICC/iUICC can store a number of MNO profiles—also referred to herein as eSIMs—and can eliminate the need to include UICC-receiving bays in wireless devices. The use of multiple SIMs and/or eSIMs is expected to offer flexibility for access to multiple services of multiple wireless networks.

Bearer Independent Protocol (BIP) messages are used as part of a SIM toolkit (STK) to establish data connections between a wireless device and a wireless network via radio bearers independent of the physical layer radio technology, e.g., fourth generation (4G) long term evolution (LTE), 5G new radio (NR), 6G, etc. Session Management (SM) procedures can be used to establish packet data network (PDN), packet data unit (PDU) connections. A wireless network can reject a request to establish a PDN/PDU connection for various reasons. In numerous cases, detailed information regarding one or more causes for the rejection may not be able to be communicated to a secure element, e.g., a UICC, eUICC, or iUICC, involved establishing the data connection. In some circumstances the secure element may repeatedly initiate request for a data connection which cannot be satisfied, resulting in wasteful use of resources at the wireless device. There is a need for techniques to enhance communication of BIP messages to accommodate protocol failures.

### SUMMARY

The described embodiments relate to wireless communications, including methods and apparatus to manage bearer independent protocol (BIP) message communication at a wireless device responsive to protocol failures, such as during session management procedures to establish a data connection with a cellular wireless network. One or more network entities of a cellular wireless network can reject establishment of a packet data network (PDN), packet data unit (PDU) connection due to various reasons, such as incompatibility between parameters of the request and an endpoint for the connection or capabilities or operating conditions of the cellular wireless network. In some cases rejection causes can be of a permanent type, where the wireless device should not reattempt the connection request with identical parameters. In some cases rejection causes can be of a temporary type, where the wireless device can reattempt the connection request after a backoff timer period. Rejection causes can be applicable to a particular radio access technology (RAT) and/or public land mobile network (PLMN) configuration (e.g., a slice configuration or user equipment route selection policy (URSP) rules). In some cases a wireless device encounters Internet Protocol (IP) address related errors such as failure of a Stateless Address Auto-Configuration (SLAAC) procedure. For example, a wireless device may not receive response to a router advertisement (RA) for Router Selection (RS) packets. Alternatively, an IP address type may be mismatched between the wireless device (or a SIM/eSIM of the wireless device) and a network allocated IP address. To accommodate various protocol failures, information regarding the protocol failure is communicated to a secure element of the device, e.g., to a UICC, eUICC, or iUICC, regarding properties of the failure. In some embodiments, the baseband component of the wireless device responds to a data connection establishment request from the secure element, after receipt (or detection) of a protocol failure notification regarding the data connection, with a response that includes information regarding the failure. In some embodiments, the baseband component indicates whether the protocol failure is permanent, in which case the secure element can refrain from reattempting the data connection with identical parameters, e.g., avoid reuse of an particular access point name (APN) value and/or an IP address type value. In some embodiments, the baseband component indicates whether the protocol failure is temporary, which case the secure element refrains from reattempting the data connection with identical parameters for a backoff time period. For a temporary protocol failure, the baseband component can indicate a backoff timer information, such as a backoff time period, a backoff timer value, a time stamp value, etc. In some embodiments, the baseband component responds to the secure element with a terminal response message that includes a general result that indicates a BIP protocol error and an additional result that includes a cause code that specifies additional information about the BIP protocol error, e.g., whether the BIP protocol error is permanent or temporary, a specific reason for the BIP protocol error. In some embodiments, the additional result includes backoff timer information. In some embodiments, the baseband component responds to the secure element with a terminal response message that includes a general result that indicates a permanent BIP protocol error or a temporary BIP protocol error and an additional result that includes a cause code that specifies additional information regarding the BIP protocol error, such as a specific reason for the BIP protocol error and/or backoff timer information.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a mobile wireless device of the system of FIG. 1, according to some embodiments.

FIG. 3A illustrates a flow diagram of an exemplary session management (SM) procedure failure, according to some embodiments.

FIG. 3B illustrates a flow diagram of an exemplary stateless address auto-configuration (SLAAC) procedure failure, according to some embodiments.

FIG. 3C illustrates a flow diagram of an exemplary Internet Protocol (IP) address type mismatch failure, according to some embodiments.

FIG. 3D illustrates a flow diagram of an example of a bearer independent protocol (BPI) session deactivation procedure, according to some embodiments.

FIGS. 4A and 4B illustrate flow diagrams of exemplary enhanced messaging to mitigate bearer independent protocol (BIP) procedure failures, according to some embodiments.

FIG. 4C illustrates a table of exemplary BIP error codes to enhance BIP error messaging for various protocol failures, according to some embodiments.

FIGS. 4D and 4E illustrate tables of exemplary information elements of a terminal response message to enhance BIP error messaging to a secure element, according to some embodiments.

FIGS. 4F and 4G illustrate tables of exemplary packet data network (PDN) packet data unit (PDU) rejection cause values for various protocol failures with exemplary enhancements proposed for BIP error messaging to a secure element, according to some embodiments.

FIG. 4H illustrates a flow diagram of exemplary enhanced messaging to mitigate a BIP session link failure, according to some embodiments.

FIG. 4I illustrates a table of exemplary information elements of an envelope command for a channel status event to enhance BIP error messaging for an BIP session link failure, according to some embodiments.

FIG. 5A illustrates a flow chart of an exemplary method to manage BIP messages for protocol failures, according to some embodiments.

FIG. 5B illustrates a flow chart of another exemplary method to manage BIP messages for protocol failures, according to some embodiments.

FIG. 5C illustrates a flow chart of a further exemplary method to manage BIP messages for protocol failures, according to some embodiments.

FIG. 5D illustrates a flow chart of an additional exemplary method to manage BIP messages for protocol failures, according to some embodiments.

FIG. 6 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

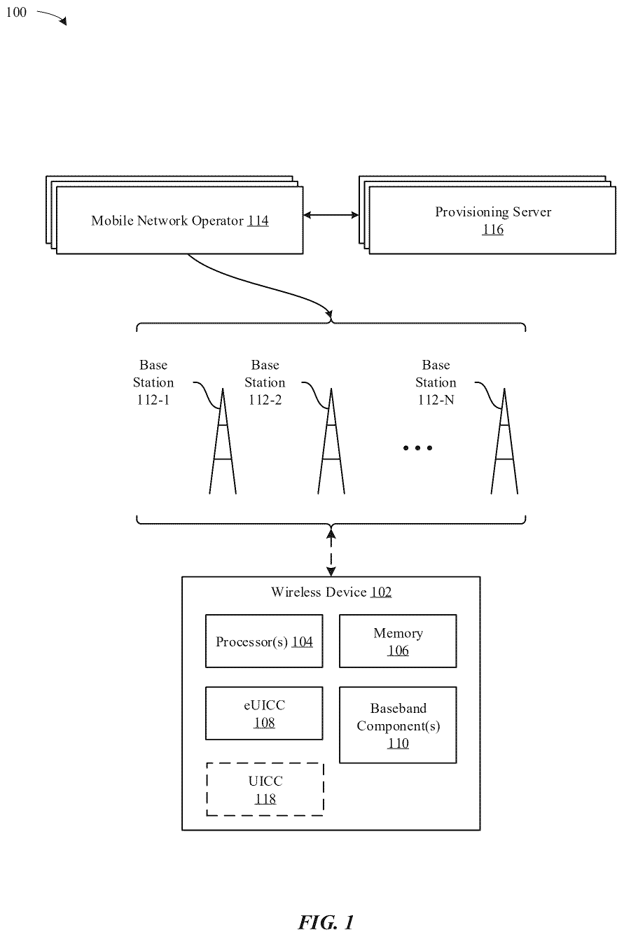

These and other embodiments are discussed below with reference to FIGS. 1 through 6; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1, 112-2, . . . , 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1, 112-2, . . . , 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1, 112-2, . . . , 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver.

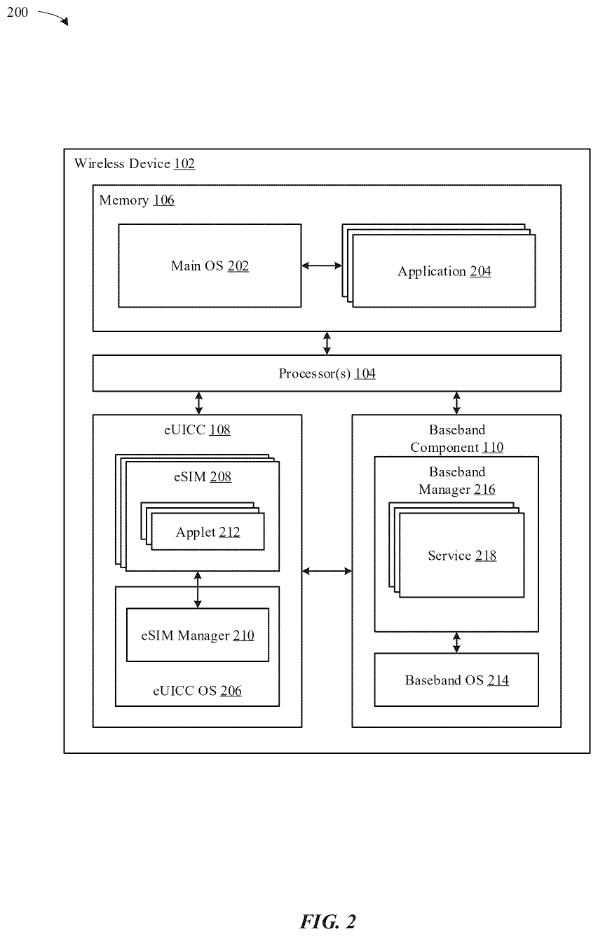

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

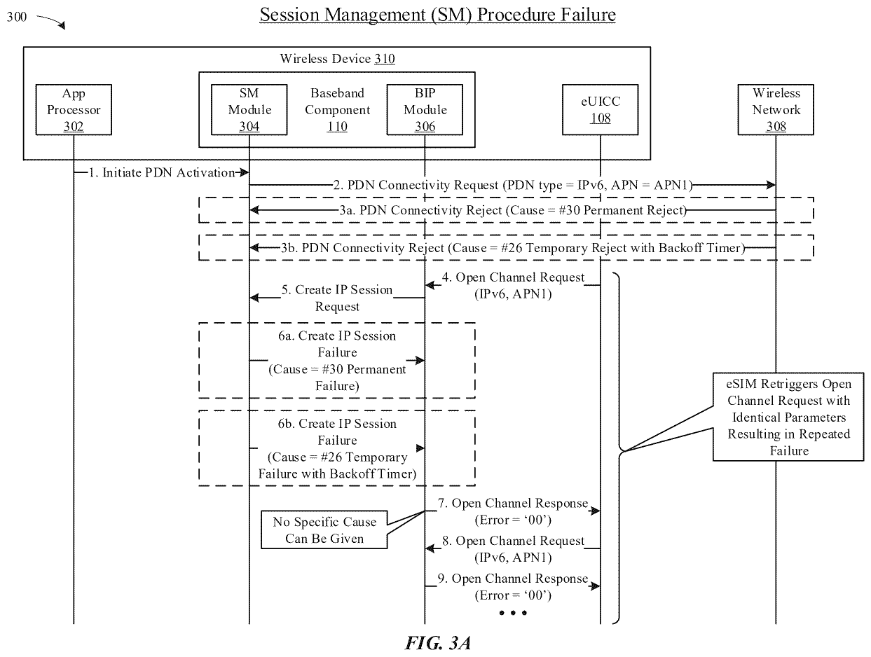

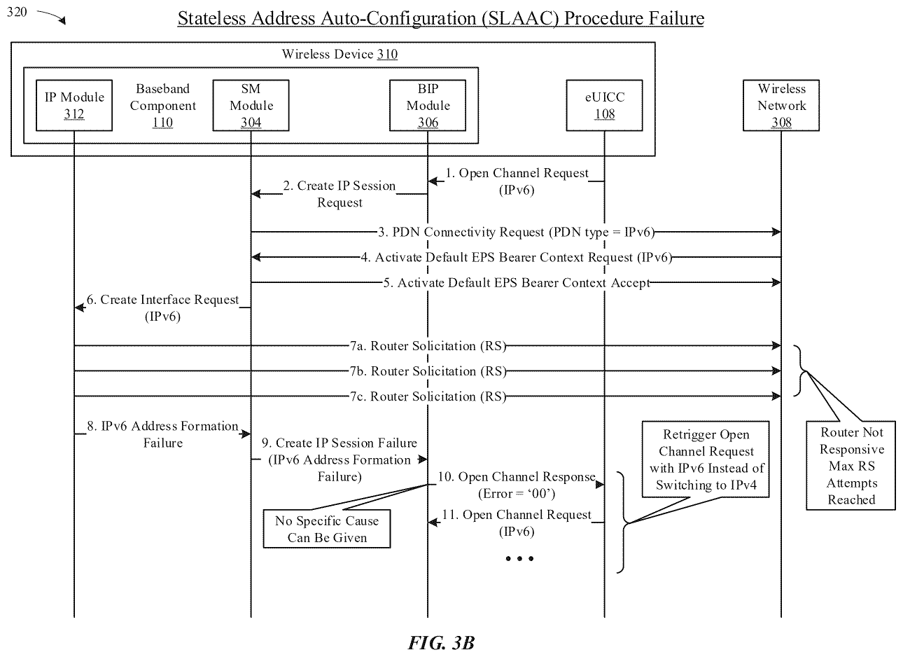

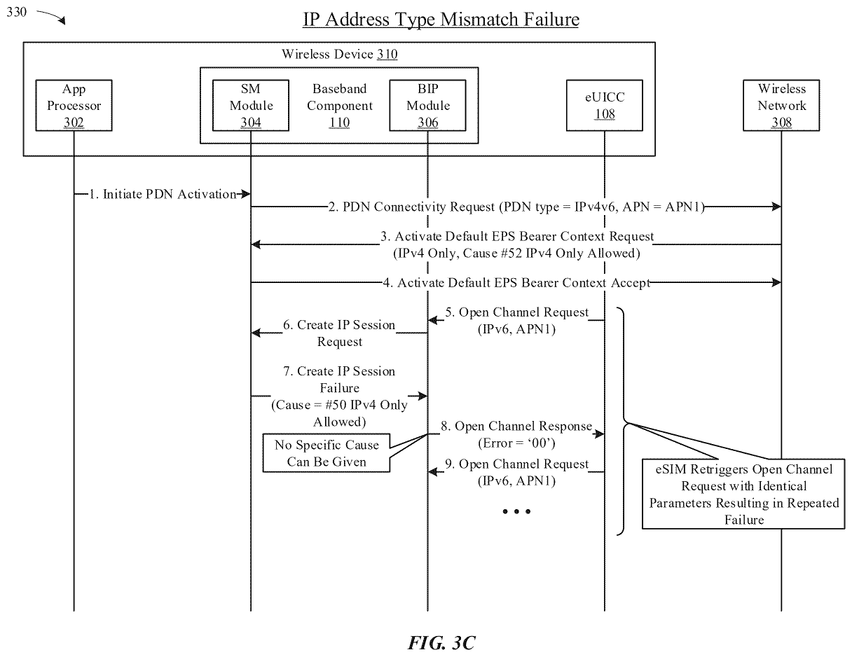

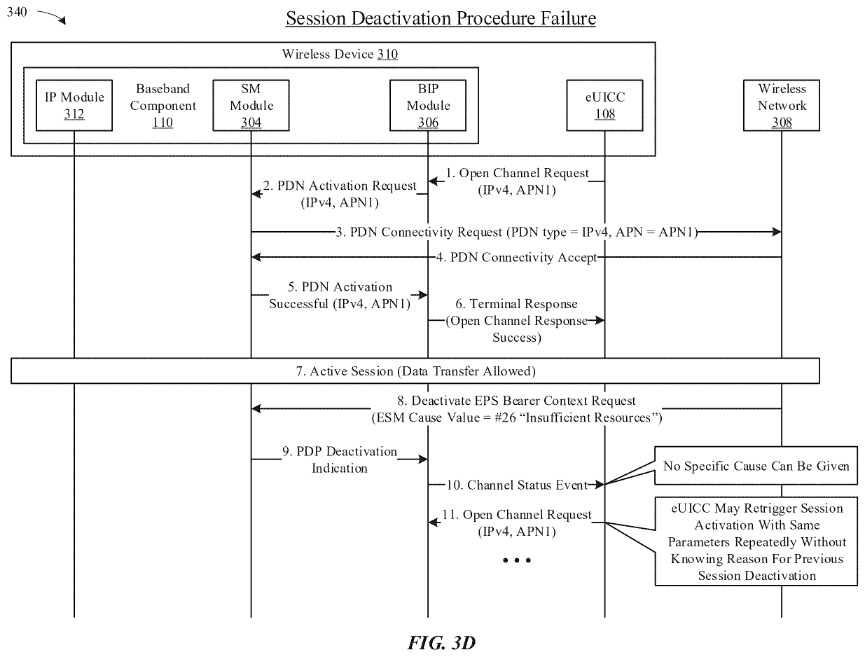

FIG. 3A illustrates a flow diagram 300 of an exemplary Session Management (SM) procedure failure that can occur during an attempt to establish a data connection between a wireless device 310 and a wireless network 308. An exemplary embodiment of wireless device 310 can be wireless device 102 and/or one or more components of the wireless device 102 (e.g., processor(s) 104, memory 106, baseband component(s) 110, eUICC 108, UICC 118, etc.) In the exemplary procedure illustrated by the flow diagram 300 of FIG. 3A, the wireless device 310 attempts to establish a packet data network (PDN) connection, in accordance with a 4G LTE radio access technology (RAT), with a wireless network 308. A similar connectivity request based on a different RAT, e.g., a packet data unit (PDU) connection request in accordance with a 5G NR RAT, or a comparable data connection request in accordance with an applicable RAT can result in a similar failure for a BIP session procedure. The solutions presented herein for handling BIP failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. At one, an applications processor 302 of the wireless device 310 communicates with an SM module 304 included in a baseband component 110 of the wireless device 310 to initiate activation of a packet data network (PDN) connection with a wireless network 308. At two, the SM module 304 can send to the wireless network 308 a PDN connectivity request message that includes specific parameter values for the requested PDN connection, e.g., specifying a PDN type that uses an IPv6 type address and an endpoint, e.g., access point name (APN) having the value APN1. At three, the wireless network 308 can respond to the PDN connectivity request message with one of two different PDN connectivity reject messages, the first reject message indicating a permanent rejection, and the second reject message indicating a temporary rejection. In the first example, at three-a, the wireless network 308 responds to the SM module 304 of the wireless device 310 with a PDN connectivity reject message that includes a cause value (#30) indicating a permanent rejection of the particular PDN connectivity request message by a network server gateway or PDN gateway. In the second example, at three-b, the wireless network 308 responds to the SM module 304 of the wireless device 310 with a PDN connectivity reject message that includes a cause value (#26) indicating a temporary rejection of the particular PDN connectivity request message with a backoff timer indication. At four, an eSIM 208 of the eUICC 108 sends, to a BIP module 306 of the baseband component 110, an open channel request message that includes the same specific parameters as the previous PDN connectivity request message, e.g., IPv6 and APN1. In response, at five, the BIP module 306 sends a create IP session request to the SM module 304. As the particular combination of parameters for the open channel request (IPv6, APN1) has been rejected, at six, the SM module 304 responds to the BIP module 306 with a create IP session failure message including the cause value obtained previously from the wireless network 308 in the PDN connectivity reject message. In the first example, at six-a, the SM module 304 responds with a create IP session failure message that includes the cause value (#30) indicating a permanent failure. In the second example, at six-b, the SM module responds with a create IP session failure message that includes the cause value (#26) indicating a temporary failure with backoff timer information. In present implementations of messaging for a BIP protocol failure, the particular cause values (#26, #30) are mapped to a generic BIP error message, i.e., at seven, the BIP module 306 responds to open channel request message from the eUICC 108 with an open channel response that includes a generic error code with byte value ‘00’. As a specific reason for failure to establish a connection is not provided, the eUICC 108 can retrigger additional open channel request messages with identical parameters that can result in repeated failures. At eight, the eUICC 108 sends to the BIP module 306 another open channel request message with the same parameter values (IPv6, APN1), and the BIP module 306 responds to the eUICC 108, at nine, with another open channel response message that includes the generic error code ‘00’. The eUICC 108 can continue to re-trigger additional open channel request messages until a maximum number of attempts have been reached. This repetition of failed requests consumes power and wastes communication resources at the wireless device 310. This can occur for both a permanent failure and a temporary failure, and in the latter case reattempts during a backoff time period specified for the temporary failure can also be rejected.

FIG. 3B illustrates a flow diagram 320 of an exemplary Stateless Address Auto-Configuration (SLACC) procedure failure that can occur in associated with establishment of a data connection between a wireless device 310 and a wireless network 308. An exemplary embodiment of wireless device 310 can be wireless device 102 and/or one or more components of the wireless device 102 (e.g., processor(s) 104, memory 106, baseband component(s) 110, eUICC 108, UICC 118, etc.) In the exemplary procedure illustrated by the flow diagram 320 of FIG. 3B, the wireless device 310 attempts to establish a packet data network (PDN) connection, in accordance with a 4G LTE radio access technology (RAT), with a wireless network 308. A similar connectivity request based on a different RAT, e.g., a packet data unit (PDU) connection request in accordance with a 5G NR RAT, or a comparable data connection request in accordance with an applicable RAT can result in a similar failure for a BIP session procedure. The solutions presented herein for handling BIP failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. After successful establishment of a PDN connection and during a SLAAC procedure an IPv6 address formation can fail due to a non-responsive router. At one, the eUICC 108 sends to a BIP module 306 of a baseband component 110 of the wireless device 310 an open channel request message with an IPv6 address type parameter value. The BIP module, at two, sends a create IP session request to an SM module 304. At three, the SM module 304 sends to the wireless network 308 a PDN connectivity request message that indicates a PDN type that uses IPv6 addressing. At four, the wireless network 308 responds to the SM module 304 of the wireless device 310 with an activate default EPS bearer context request message that indicates acceptance of the IPv6 address type. At five, the SM module 304 replies to the wireless network 308 with an activate default EPS bearer context accept message. At six, the SM module 304 sends a message to an IP module 312 a create interface request message that includes an IPv6 address type parameter value. At seven-a, seven-b, and seven-c, the IP module 312 can repeatedly send a router solicitation (RS) message to router of the wireless network as part of an RS router address (RA) formation procedure as part of a SLAAC IPv6 address procedure. As shown in FIG. 3B, the router of the wireless network 308 may be unresponsive and the IP module 312 can send multiple RS messages until a maximum number of RS attempts have been reached. The IP module 312, at eight, responds to the SM module 304 with an IPv6 address formation failure message. At nine, the SM module 304 replies to the create IP session request received at two from the BIP module 306 with a create IP session failure message indicating an IPv6 address formation failure. In present BIP error messaging protocols, there is no provision to inform the eUICC 108 of a specific cause for the resulting create IP session failure, and the BIP module 306, as a result at ten, responds to the open channel request message received at one from the eUICC 108 with an open channel response message that includes a generic error code with byte value ‘00’. As a specific reason for the failure to establish the requested connection with the properties requested (IPv6), the eUICC 108 can retrigger additional open channel request messages, e.g., at eleven, with the identical request IP address type (IPv6) instead of switching to a different IP address type, e.g., IPv4. As a result, multiple open channel requests can be triggered with multiple responses provided indicating an error with generic error code ‘00’. This repetition of failed requests consumes power and wastes communication resources at the wireless device 310.

FIG. 3C illustrates a flow diagram 330 of an exemplary IP address type mismatch failure that can occur in association with establishment of a data connection between a wireless device 310 and a wireless network 308. An exemplary embodiment of wireless device 310 can be wireless device 102 and/or one or more components of the wireless device 102 (e.g., processor(s) 104, memory 106, baseband component(s) 110, eUICC 108, UICC 118, etc.) In the exemplary procedure illustrated by the flow diagram 330 of FIG. 3C, the wireless device 310 attempts to establish a packet data network (PDN) connection, in accordance with a 4G LTE radio access technology (RAT), with a wireless network 308. A similar connectivity request based on a different RAT, e.g., a packet data unit (PDU) connection request in accordance with a 5G NR RAT, or a comparable data connection request in accordance with an applicable RAT can result in a similar failure for a BIP session procedure. The solutions presented herein for handling BIP failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. After successful establishment of a default enhanced packet service (EPS) bearer context where the wireless network 308 specified at only an IPv4 type address is permitted, the eUICC 108 can repeatedly attempt with an IPv6 type address. At one, an applications processor 302 of the wireless device 310 communicates with an SM module 304 included in a baseband component 110 of the wireless device 310 to initiate activation of a packet data network (PDN) connection with a wireless network 308. At two, the SM module 304 can send to the wireless network a PDN connectivity request message that includes specific parameter values for the requested PDN connection, e.g., specifying a PDN type that uses an IPv6 type address and an endpoint, e.g., access point name (APN) having the value APN1. At three, the wireless network 308 responds to the SM module 304 with an activate default EPS bearer context request message that includes one or more parameters, e.g., a cause value #52, indicating that only an IPv4 type address is allowed. At four, the SM module 304 responds to the wireless network 308 with an activate default EPS bearer context accept message. At five, an eSIM 208 of the eUICC 108 sends, to a BIP module 306 included in the baseband component 110 of the wireless device 310, an open channel request message that includes specific parameters specifying an IPv6 address type and a particular endpoint value, e.g., APN1. The BIP module 306, at six, sends a create IP session request to the SM module 304. As the IPv6 address type is not supported, as indicated earlier by the wireless network 308 where only an IPv4 address type is allowed, the SM module 304 responds to the BIP module 306 with a create IP session failure message indicating that only the IPv4 type address is allowed. In present implementations of messaging for a BIP protocol failure, the particular cause value (#50) is mapped to a generic BIP error message. At eight, the BIP module 306 replies to the open channel request message received from the eUICC 108 at five with an open channel response message that includes a generic error code with byte value ‘00’. No specific cause for the BIP error is provided to the eUICC 108. As a result, the eSIM 208 of the eUICC 108 can retrigger additional open channel request messages multiple times (up to a maximum reattempt), e.g., as indicated at nine for a first reattempt, with identical parameter values, e.g., IPv6 address type and APN1, which can result in repeated failures. This repetition of failed requests consumes power and wastes communication resources at the wireless device 310.

FIG. 3D illustrates a flow diagram 340 of an example of a BIP session deactivation procedure, where failure information regarding the link failure for an active (and subsequently terminated) BIP session is unable to be conveyed by the BIP module 306 to the eUICC 108 of a wireless device 310. An exemplary embodiment of wireless device 310 can be wireless device 102 and/or one or more components of the wireless device 102 (e.g., processor(s) 104, memory 106, baseband component(s) 110, eUICC 108, UICC 118, etc.) In the exemplary procedure illustrated by the flow diagram 340 of FIG. 3D, the wireless device 310 experiences a failure of an established packet data network (PDN) connection, in accordance with a 4G LTE radio access technology (RAT), with a wireless network 308. A similar data connection failure based on a different RAT, e.g., a packet data unit (PDU) connection request in accordance with a 5G NR RAT, or a comparable data connection request in accordance with an applicable RAT can result in a similar failure for a BIP session procedure. The solutions presented herein for handling BIP session failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. After successful establishment of a PDN connection with an active BIP session, data transfer can be allowed via the PDN connection; however, the wireless network 308 may terminate the PDN connection unexpectedly. Presently, there do not exist procedures to convey a reason for termination of the BIP session to the eUICC 108. Previously for FIGS. 3A, 3B, and 3C, failures to convey information regarding attempts to establish a BIP session are described, while FIG. 3D provides an example of a failure to provide additional information (e.g., cause for link failure, permanent or temporary type of link failure, or back-off timer information) when a data link failure occurs that terminates an established BIP session. At one, the eUICC 108 sends to a BIP module 306 of a baseband component 110 of the wireless device 310 an open channel request message with an IPv4 address type parameter value and an endpoint, e.g., an access point name (APN) having the value APN1. (Alternatively, the open channel request message could specify an IPv6 address type parameter value or an option to use either address type.) At two, the BIP module 306 sends a PDN activation request message that includes the IP address type and APN value to the SM module 304. At three, the SM module 304 can send to the wireless network 308 a PDN connectivity request message that includes the specific parameter values for the requested PDN connection, e.g., IPv4 address type and APN value APN1. At four, the wireless network 308 can respond to the SM module 304 with a PDN connectivity accept message indicating that the PDN connection with the requested parameters has been established. At five, the SM module 304 provides a PDN activation successful message indicating to the BIP module 306 that the PDN connection has been successfully established with the requested parameters. In some embodiments, parameters for the PDN connection may be negotiated between the SM module 304 and the wireless network 308, and an accepted set of parameters for the PDN connection may be communicated to the BIP module 306 by the SM module 304 in the PDN activation successful message. At six, the BIP module 306 responds to the open channel request message received previously with a terminal response message indicating an open channel response success. At seven, data may be transferred between the wireless device 310 and the wireless network 308 via the established PDN connection, e.g., BIP session data between the eUICC 108 and a network element of the wireless network 308 can use the established PDN connection. In some embodiments, the PDN connection and the data link for the BIP session can remain open for background BIP session data transfer. The wireless network 308 can determine to terminate the PDN connection and provide a reason for termination to the wireless device 310. For example, at eight, the wireless network 308 sends a deactivate EPS bearer context request message to the SM module 304, where the deactivation message includes an ESM cause value (#26) indicating insufficient network resources available to retain the PDN connection for the wireless device 310. At nine, the SM module 304 provides to the BIP module 306 a PDP deactivation indication, which in some cases may not include a reason. At ten, the BIP module 306 sends to the eUICC 108 a channel status event message that indicates that the previously open channel (the PDN connection previously established) has been closed. No specific cause can be provided in the channel status event message and therefore the eUICC 108 can be unaware of the reason for the channel termination. Without knowledge of a PDN connection failure cause, e.g., whether the termination is of a permanent type for the parameters previously used for the PDN connection or of a temporary type with a backoff timer value, the eUICC 108 can retrigger a BIP session activation using the same (previously used) parameters to re-establish (or attempt to re-establish) an PDN connection. In some circumstances, the eUICC 108 may retrigger BIP session activation attempts repeatedly using parameter values that cannot be supported by the wireless network 308.

To accommodate protocol failures that can occur as part of BIP procedures, SLAAC procedures, or other data connection establishment procedures, information included in BIP response messages can be extended as described herein. In some embodiments, enhancements and extensions to the ETSI TS 102 223 communication standard are proposed. In some embodiments, information can be included in BIP response messages to indicate whether a protocol failure is permanent, which indicates that the eUICC 108 should not reattempt the open channel request with identical parameters, or is temporary, which indicates that the eUICC 108 may reattempt the open channel request with the same parameters after a backoff time period. In some embodiments, for a temporary protocol failure, backoff timer information can be communicated to the eUICC 108, such as a time duration for a backoff timer period, a timestamp value after which a retry can occur, or an indication that the eUICC 108 should wait until receiving an indication from the BIP module 306 that a reattempt is permitted (e.g., where the BIP module 306 of the baseband component 110 can maintain a backoff timer). With enhanced BIP messaging, the eUICC 108 can obtain additional information regarding a PDN/PDU establishment failure and avoid retriggering multiple attempts with identical parameters that can repeatedly fail. Enhanced BIP message can be used to provide information to the eUICC 108 during establishment of (or attempts to establish) a PDN/PDU connection for a BIP session and/or after establishment of a PDN/PDU connection for an ongoing BIP session.

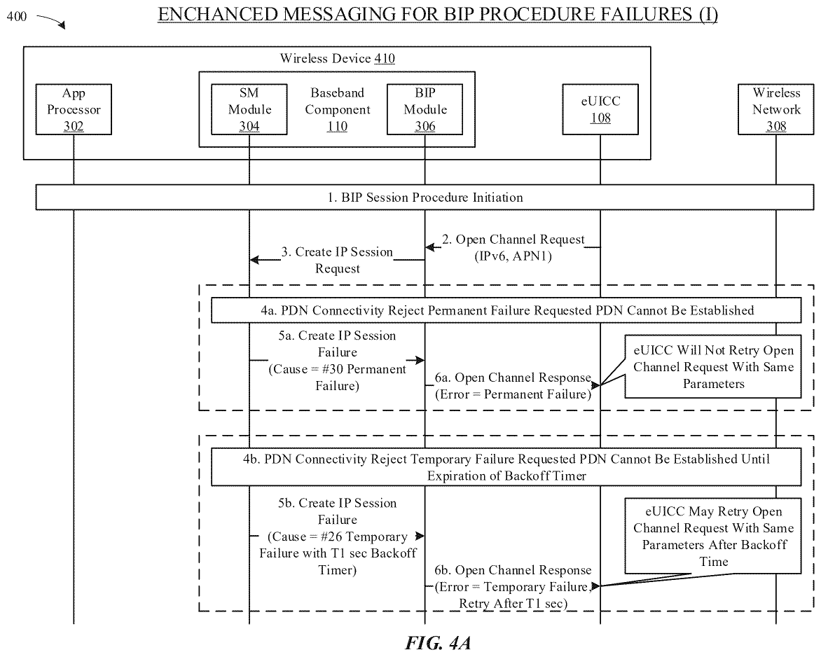

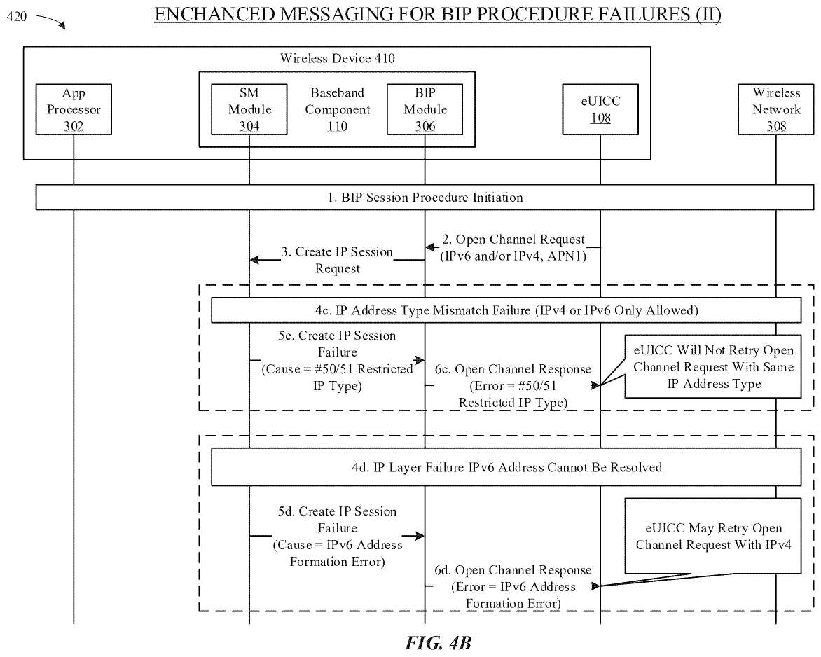

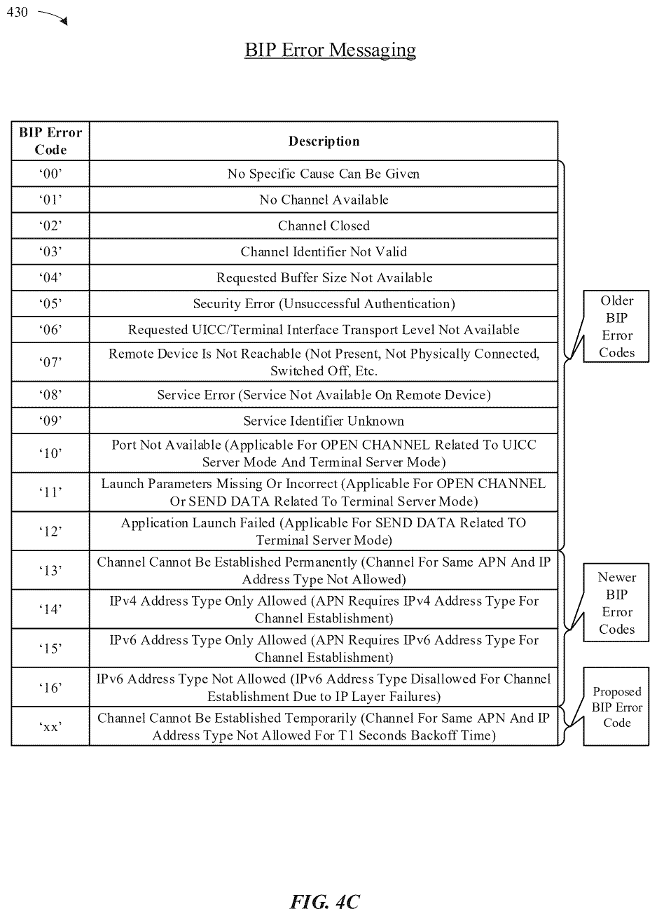

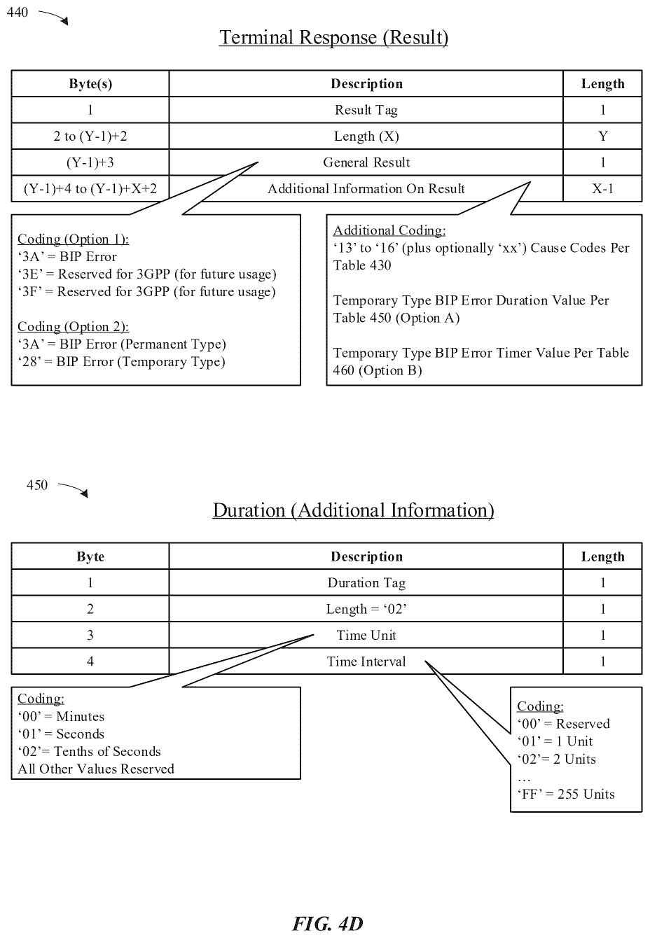

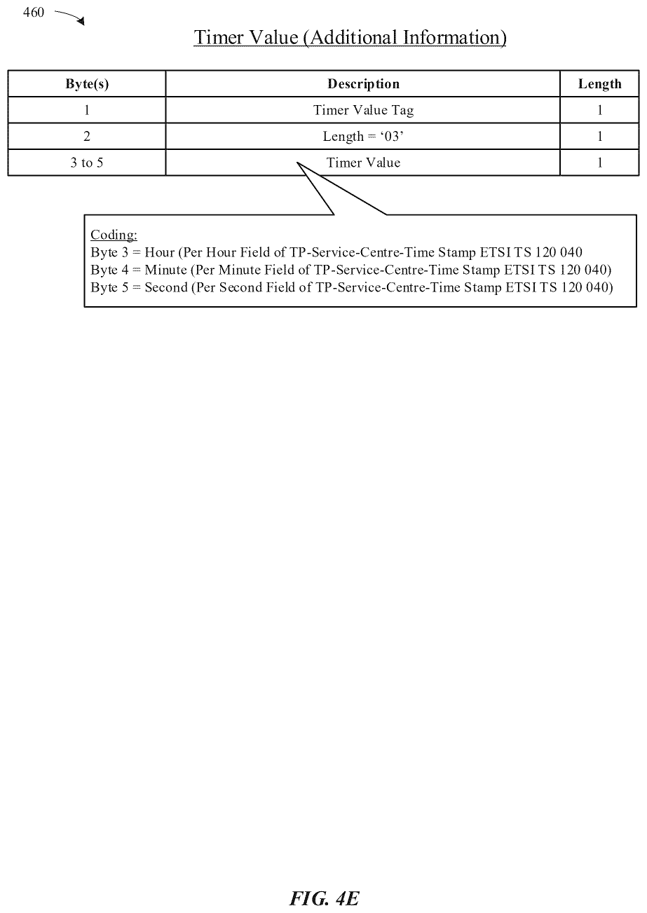

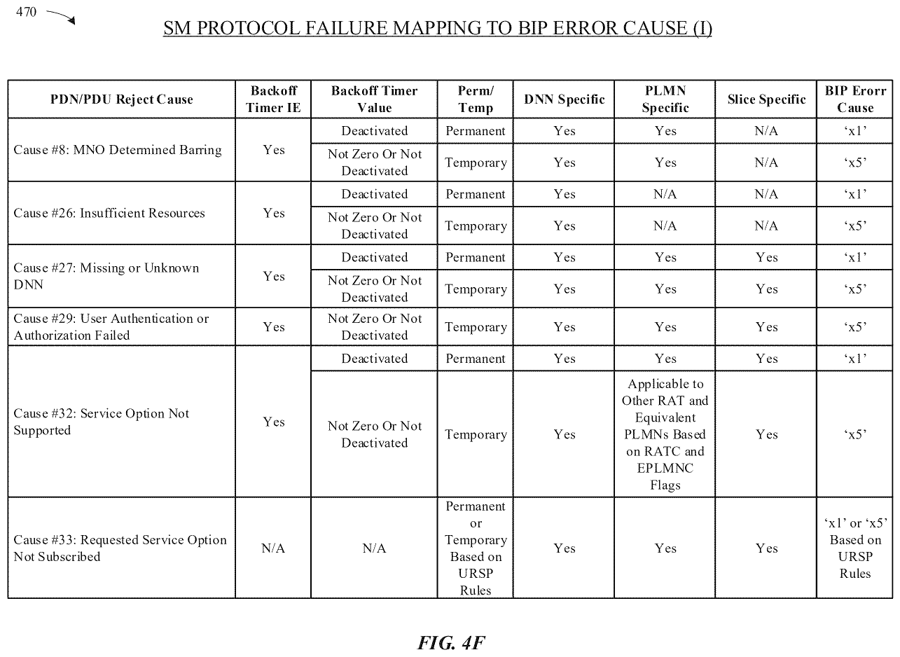

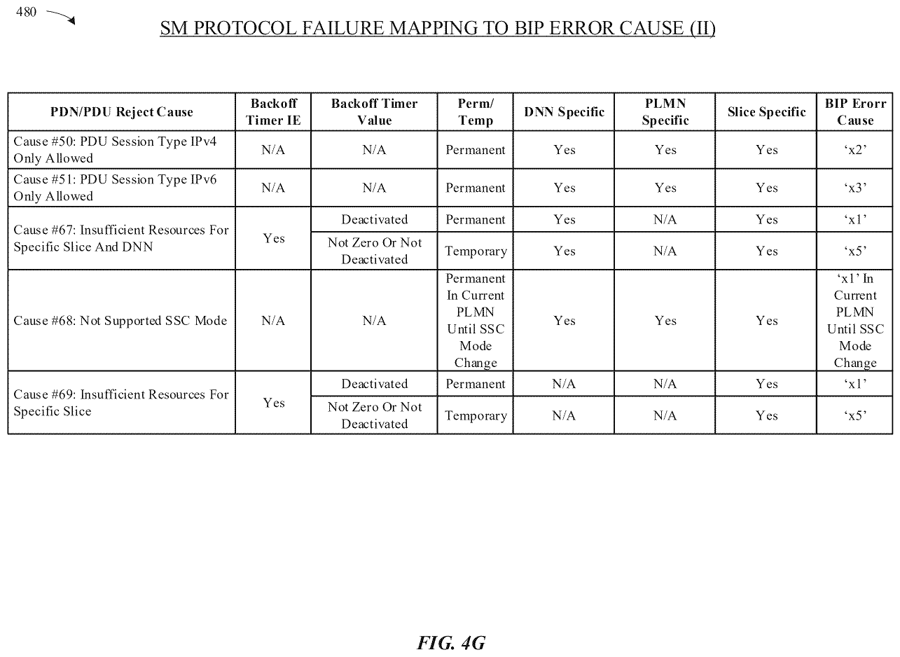

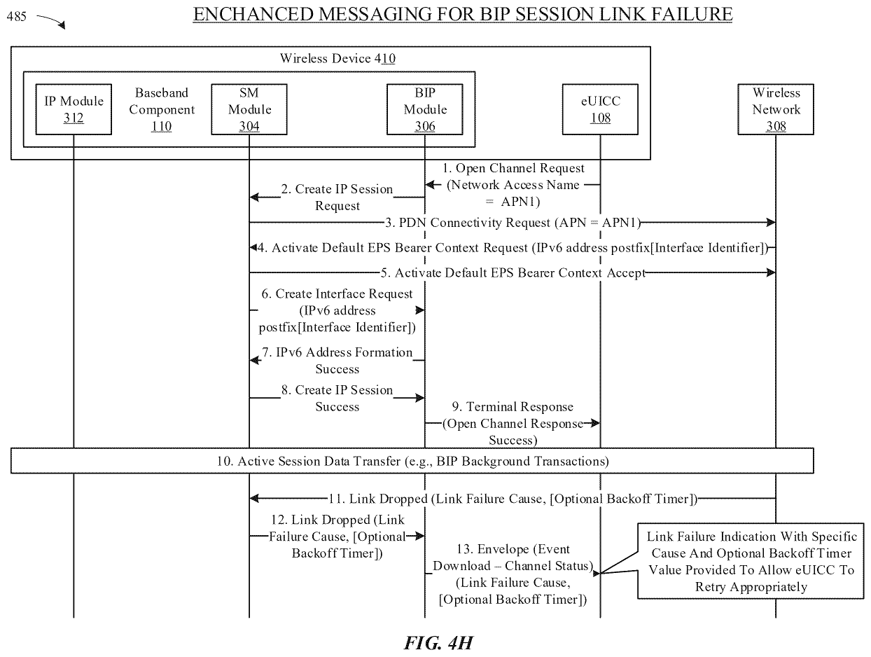

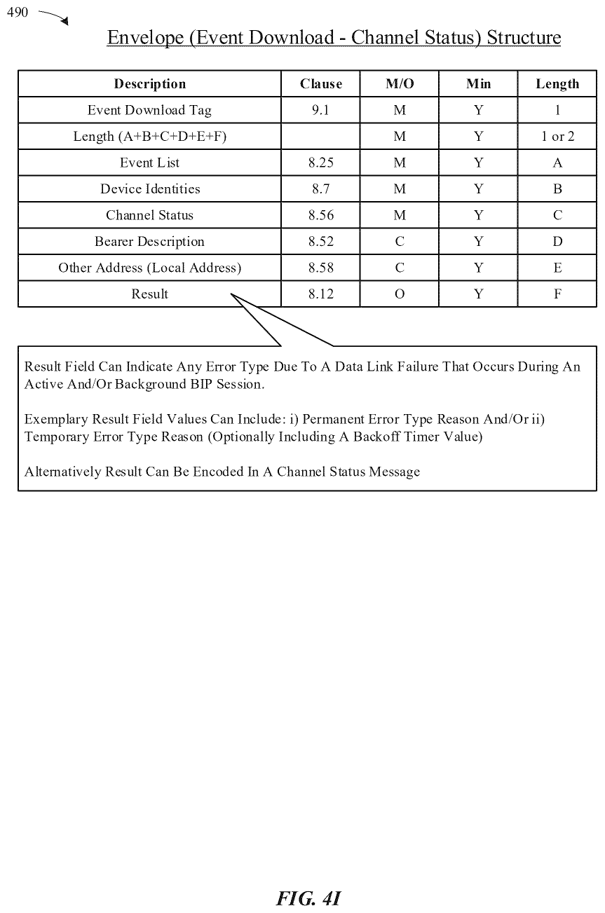

FIG. 4A illustrates a flow diagram 400 of an example of enhanced messaging for a BIP protocol failure associated with establishment of a data connection between a wireless device 410 and a wireless network 308. An exemplary embodiment of wireless device 410 can be wireless device 102 and/or one or more components of the wireless device 102 (e.g., processor(s) 104, memory 106, baseband component(s) 110, eUICC 108, UICC 118, etc.). The solutions presented herein for handling BIP failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. At one, an applications processor 302, a baseband component 110, and/or an eUICC 108 of the wireless device 410 can initiate a BIP session procedure with one or more network entities of a wireless network 308. For example, the applications processor 302 can communicate with an SM module 304 included in the baseband component 110 to initiate activation of a PDN/PDU connection with the wireless network 308. At two, an eSIM 208 of the eUICC 108 sends, to a BIP module 306 of the baseband component 110, an open channel request message that includes the same specific parameters as the previous PDN connectivity request message, e.g., IPv6 and APN1. In response, at three, the BIP module 306 sends a create IP session request to the SM module 304. As further indicated, under different scenarios the IP session may be unable to be created with the parameters specified and as a result the open channel request from the eUICC 108 can be unable to be satisfied.

In a first example, at four-a, a PDN connectivity request to the wireless network 308 by the SM module 304 can be rejected with an indication of a permanent type failure, where the requested PDN cannot be established with one or more of requested parameters included in the PDN connectivity request message. At five-a, the SM module 304 responds to the create IP session request from the BIP module 306 with a create IP session failure message that includes the cause value (#30) indicating a permanent failure. At six-a, the BIP module 306 responds to the open channel request message received from the eUICC 108 with an open channel response message that includes an indication that a permanent type failure has occurred. As a result of the indication of a permanent type failure, the eUICC 108 can be configured to refrain from retrying an open channel request with identical parameters as previously used. For example change one or more parameters, e.g., to use a different IP address type or to connect to a different endpoint specified by a different APN value.

In a second example, at four-b, a PDN connectivity request to the wireless network 308 by the SM module 304 can be rejected with an indication of a temporary type failure, where the requested PDN cannot be established with one or more of requested parameters included in the PDN connectivity request message and should not be reattempted until after a backoff time period, e.g., after expiration of a backoff timer. At five-b, the SM module responds with a create IP session failure message that includes the cause value (#26) indicating a temporary failure with backoff timer information, e.g., with a backoff timer duration value of T1 seconds or another similar backoff time indication. At six-b, the BIP module 306 responds to the open channel request message received from the eUICC 108 with an open channel response message that includes an indication of that a temporary failure has occurred with an indication of a backoff time period, e.g., T1 seconds, after which the eUICC 108 may be allowed to reattempt the open channel request with the same parameters as previously used.

FIG. 4B illustrates a flow diagram 420 of additional examples of enhanced messaging for a BIP protocol failure associated with establishment of a data connection between a wireless device 410 and a wireless network 308. An exemplary embodiment of wireless device 410 can be wireless device 102 and/or one or more components of the wireless device 102 (e.g., processor(s) 104, memory 106, baseband component(s) 110, eUICC 108, UICC 118, etc.) The solutions presented herein for handling BIP failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. As shown in FIG. 4B, at one, an applications processor 302, a baseband component 110, and/or an eUICC 108 of the wireless device 410 can initiate a BIP session procedure with one or more network entities of a wireless network 308. For example, the applications processor 302 can communicate with an SM module 304 included in the baseband component 110 to initiate activation of a PDN/PDU connection with the wireless network 308. At two, an eSIM 208 of the eUICC 108 sends, to a BIP module 306 of the baseband component 110, an open channel request message that includes the same specific parameters as the previous PDN connectivity request message, e.g., IPv6 and APN1. In response, at three, the BIP module 306 sends a create IP session request to the SM module 304. As further indicated, under different scenarios the IP session may be unable to be created with the parameters specified and as a result the open channel request from the eUICC 108 can be unable to be satisfied.

In a third example, at four-c, an IP address type mismatch failure can occur, e.g., either only an IPv4 type address or only an IPv6 type address can be allowed and a mismatch may exist between the IP address type allowed by one or more network entities of the wireless network 308 and an IP address type requested by the eUICC 108. At five-c, the SM module 304 responds to the create IP session request from the BIP module 306 with a create IP session failure message that includes a cause value (#50 or #51) indicating a restricted IP address type is required. At six-c, the BIP module 306 responds to the open channel request message received from the eUICC 108 with an open channel response message that includes an indication that an error regarding IP address type restriction has occurred. As a result of the indication of the IP address type restriction, the eUICC 108 will not reattempt the open channel request with an identical IP address type. In some embodiments, the eUICC 108 may reattempt the open channel request with an IP address type that conforms to the IP address type restriction, e.g., where a particular IP address type is specified, such as IPv4 or IPv6 only required, or where a particular IP address type is denied, e.g., IPv4 or IPv6 disallowed. In some embodiments, the open channel response message can indicate that the IP address type restriction is of a permanent type. In some embodiments, the open channel response message can indicate that the IP address type restriction is of a temporary type.

In a fourth example, at four-d, an IP layer failure occurs, e.g., where an IPv6 address cannot be resolved. At five-d, the SM module 304 responds to the create IP session request from the BIP module 306 with a create IP session failure message that includes the cause value indicating an IPv6 address formation error. At six-d, the BIP module 306 responds to the open channel request message received from the eUICC 108 when an open channel response message that includes an indication that an IPv6 address formation error has occurred. As a result of the indication of the IPv6 address formation error, the eUICC 108 retry an open channel request with an IPv4 address type in place of an IPv6 address type. In some embodiments, the open channel response message can indicate that the IP address formation error is of a permanent type. In some embodiments, the open channel response message can indicate that the IP address formation error is of a temporary type.

FIG. 4C illustrates a table 430 of BIP error message codes with associated description types. In some embodiments, table 430 corresponds to a set of BIP error message codes specified in a version of a 3 GPP 31.111 standard or an ETSI TS 102 223 standard. The table 430 includes newer BIP error codes labeled as ‘13’ to ‘16’ and a proposed BIP error code labeled as ‘xx’, where the newer and/or proposed BIP error codes allow for providing additional failure information to an eUICC 108 in one or more BIP messages. In some embodiments, a first BIP error code with the value ‘13’ can indicate that a channel cannot be established permanently, i.e., a channel having an identical APN value and/or IP address type is not allowed to be established as previously requested. In some embodiments, a second BIP error code with the value ‘14’ can indicate that only an IPv4 address type is allowed, i.e., an endpoint specified by an APN value requires an IPv4 address type to establish a channel. In some embodiments, a third BIP error code with the value ‘15’ can indicate that only an IPv6 address type is allowed, i.e., an endpoint specified by an APN value requires an IPv6 address type to establish a channel. In some embodiments, a fourth BIP error code with the value ‘16’ can indicate that an IPv6 address type is not allowed, i.e., an IPv6 address type is disallowed for channel establishment due to IP layer failures. In some embodiments, a proposed BIP error code with the placeholder value ‘xx’ can indicate that a channel cannot be established temporarily, e.g., an channel with identical APN and/or IP address type is not allowed for a backoff time period, such as for T1 seconds.

FIGS. 4D and 4E illustrate tables defining exemplary values for information elements of a terminal response message that can be communicated from a processor, e.g., a baseband component 110, to a secure element, e.g., an eUICC 108 or a UICC 118, as part of a BIP procedure. Table 440 outlines a terminal response result message that includes a first byte having a result tag value, indicating the message is a result, followed by a length information element (IE), a general result IE and an additional information on result IE. In a first option for enhanced BIP protocol messaging to improve information communicated to a secure element regarding BIP procedure failures, the general result IE can use the byte code ‘3A’ value to indicate a BIP error without clarifying whether the BIP protocol error is of a permanent type or of a temporary type. In this first option, the additional information on result IE can include one of the newer (or proposed) BIP error cause codes outlined in table 430 of FIG. 4C, e.g., one of the values ‘13’ through ‘16’ (or optionally ‘xx’) to indicate whether a data connection cannot be established with parameters as requested, where the rejection can be temporary or permanent, or in some cases where an IP address type requirement is indicated. When the BIP error cause code indicates a temporary rejection, a duration IE as outlined in table 450 can be included in the additional information on result IE with coding to indicate a time duration value for a backoff time period during which the secure element (e.g., eUICC 108 or UICC 118) should refrain from reattempting the same open channel request with one or more of the same parameters used in the request that resulted in the rejection by the wireless network. In some embodiments, a backoff timer and/or duration value can be included in the additional information on result IE as a separate tag length value (TLV) or the terminal response result IE can be extended to include additional bytes specifying a backoff timer and/or duration value.

In a second option for enhanced BIP protocol messaging to improve information communicated to a secure element regarding BIP procedure failures, the general result IE can use the byte code ‘3A’ value to indicate a BIP error of a permanent type, or a byte code ‘28’ to indicate a BIP error of a temporary type. For a permanent BIP error, the secure element (and/or a SIM/eSIM or other application on the secure element) should refrain from reattempting an identical command, e.g., an open channel request message with identical parameters as previously used that generated the BIP error terminal response, as the same BIP error can be expected to re-occur. The permanent BIP error restriction on resending identical parameter commands can be reset after a re-initialization of the secure element. For a temporary BIP error, additional backoff timer information can be provided, such as by including the duration IE from table 450 in the additional information on result IE of the terminal response result IE of table 440. In some embodiments, in place of a duration IE that specifies a time interval, a time stamp value can be used, where the time stamp value can be included in a timer value IE of the additional information on result IE of the terminal response IE. An exemplary structure for the timer value IE is detailed in table 460 of FIG. 4E.

For both the first option and the second option for enhanced BIP protocol messaging, the additional information on result IE can include a cause code, e.g., one of the values ‘13’ through ‘16’ (or optionally ‘xx’) to clarify why the previous open channel request was rejected. The cause code values can provide the secure element with information that enables the secure element to provide a subsequent open channel request message that will be less likely to be rejected by the wireless network.

FIGS. 4F and 4G illustrates tables 470 and 480 that summarize various rejection cause values that can be received during a procedure to establish a PDN/PDU connection with a wireless network. An exemplary mapping of the multiple PDN/PDU rejection cause values to BIP error cause values that can be included in the BIP messaging terminal response is provided; however, it is understood that different mappings and/or different sets of BIP error cause values can also be used. In some embodiments, an indication of whether a PDN/PDU rejection cause is of a permanent type or a temporary type is included in the BIP messaging terminal response. In some embodiments, a PDN/PDU rejection cause may be specific to a particular public land mobile network (PLMN) and therefore a change in PLMN can indicate that the previous request may be reattempted. In some embodiments, the PDN/PDU rejection cause may be specific to applicable to multiple equivalent PLMNs and/or applicable to multiple radio access technologies (RATs) based on a RATC flag and/or an EPLMNC flag. In some embodiments, the PDN/PDU rejection may be specific to a particular slice of a wireless network and therefore a change in slice configuration can indicate that the previous request may be reattempted. In some embodiments, selection of which of multiple BIP error cause values, e.g., one or ‘13’ to ‘16’ (or optionally ‘xx’), to include in the BIP messaging terminal response can be based on one or more user equipment route selection policy (URSP) rules. In some embodiments, the PDN/PDU rejection may be of a temporary type and a backoff timer indication (e.g., duration or timestamp) value may be provided by the wireless network and may be included (or indicated) in the BIP messaging terminal response. In some embodiments, the PDN/PDU rejection indicates that one or more particular IP address types are required or that one or more particular IP address types are disallowed, and the BIP error cause value included in the BIP messaging terminal response may provide an indication (at least in part) of the IP address type restriction.

In some embodiments, a wireless device 102 can operate with a secure element, e.g., a UICC 118 and/or an eUICC 108, that does not comply with one or more requirements for BIP error cause value enhancements as discussed herein. In some embodiments, one or more processors (e.g., a baseband component 110) of a wireless device communicatively coupled to the secure element can determine whether a repeated open channel request message with identical parameters is received from the secure element, where a PDN/PDU rejection cause of a permanent type was communicated via a BIP error cause value in a BIP messaging terminal response previously to the secure element. The one or more processors (e.g., a baseband component) of the wireless device can disable one or more applicable terminal profile bits (e.g., disable class e, k, f support) for a user equipment (UE) implementation specific duration to reduce impact of the repeated open channel request messages on the one or more processors of the wireless device. In some embodiments, a forced disablement can occur and later be removed when the one or more processors (e.g., a baseband component) of the wireless device determines recovery from previous PDN/PDU rejections (or other data connection establishment failures) has occurred and SM procedures initiated by the secure element can resume. In some embodiments, recovery can include a change in a registration or location area indicator value. In some embodiments, recovery can include removal and reinsertion of a UICC 118. In some embodiments, recovery can include refresh, reset, and/or re-initialization of the secure element.

FIG. 4H illustrates a flow diagram 485 of an example of enhanced message for a BIP session link failure associated with a PDN connection between a wireless device 410 and a wireless network 308. An exemplary embodiment of wireless device 410 can be wireless device 102 and/or one or more components of the wireless device 102 (e.g., processor(s) 104, memory 106, baseband component(s) 110, eUICC 108, UICC 118, etc.). In the exemplary procedure illustrated by the flow diagram 485 of FIG. 4H, the wireless device 310 experiences a failure of an established packet data network (PDN) connection, in accordance with a 4G LTE radio access technology (RAT), with a wireless network 308. A similar data connection failure based on a different RAT, e.g., a packet data unit (PDU) connection request in accordance with a 5G NR RAT, or a comparable data connection request in accordance with an applicable RAT can result in a similar failure for a BIP session procedure. The solutions presented herein for handling BIP session failure scenarios, illustrated by failures of PDN/PDU connections can apply equally to different available or under development RATs, such as 4G LTE, 5G NR, Wi-Fi, or 6G. The use of a PDN/PDU data connection failure (during and/or after establishment of the PDN/PDU data connection) that results in a BIP failure should be understood as a non-limiting example. At one, the eUICC 108 sends to a BIP module 306 of a baseband component 110 of the wireless device 410 an open channel request message with IP address type parameter value (e.g., IPv4 and/or IPv6, not explicitly shown) and an endpoint, e.g., an access point name (APN) having the value APN1. At two, the BIP module 306 sends a create IP session request message, which includes the IP address type and the APN value, to the SM module 304. At three, the SM module 304 can send to the wireless network 308 a PDN connectivity request message that includes the specific parameter values for the requested PDN connection, e.g., IP address type and APN value APN1. At four, the wireless network 308 can respond to the SM module 304 with an activate default EPS bearer context request message with specific parameters used for the established PDN connection, e.g., IPv6 address type 6. At five, the SM module 304, replies to the wireless network 308 with an activate default EPS bearer context accept message indicating acceptance of the PDN connection with parameters as specified by the wireless network 308. At six, the SM module 304 provides to the BIP module 306 a create interface request message indicating that a PDN connection with particular parameters has been established. In some embodiments, parameters for the PDN connection may be negotiated between the SM module 304 and the wireless network 308, and an accepted set of parameters for the PDN connection may be communicated to the BIP module 306 by the SM module 304 in the create interface request message. At seven, the BIP module 306 responds to SM module with an IP address formation success message confirming acceptance of the PDN connection with the specified IP address type. At eight, the SM module 304 responds to the BIP module 306 with a create IP session success message indicating successful establishment of the IP session requested at two. At nine, the BIP module 306 sends to the eUICC 108 a terminal response message indicating successful establishment of the open channel requested by the eUICC 108 previously at one. At ten, data may be transferred between the wireless device 410 and the wireless network 308 via the established PDN connection, e.g., BIP session data between the eUICC 108 and a network element of the wireless network 308 can use the established PDN connection. In some embodiments, the PDN connection and the data link for the BIP session can remain open for background BIP session data transfer. The wireless network 308 can determine to terminate the PDN connection and provide a reason for termination to the wireless device 410. For example, at eleven, the wireless network 308 sends a link dropped message to the SM module 304, where the link dropped messages includes a link failure cause value, and optionally (for a temporary failure) a backoff timer value. The link failure cause value can indicate whether the failure is of a permanent type, where identical parameters as used for the PDN connection may not be supported by the wireless network 308 for another PDN connection request or of a temporary type, where a PDN connection with identical parameters may be requested to be established after a backoff period of time, which can be specified by a backoff timer value. At twelve, the SM module 304 provides to the BIP module 306 a link dropped message, which may include the link failure cause value and optionally, such as for a temporary failure, a backoff timer value. At thirteen, the BIP module 306 sends to the eUICC 108 an envelope command of an event download - channel status type that indicates that the PDN connection for the BIP session has been dropped. The envelope command can include a link failure cause value that indicates an error type, e.g., a permanent error type, a temporary error type, and optionally may include a backoff timer value for a temporary error type. The link failure cause value can provide information to the eUICC 108 to allow the eUICC to retry establishment of a PDN connection with appropriate parameter values at a future time when the wireless network 308 may support the request for the PDN connection from the wireless device 410. In some embodiments, a result field is included in a channel status event information element to accommodate indicating different types of errors for a PDN connection link failure, e.g., that can occur during an active and/or background BIP session.

FIG. 4I illustrates a table 490 of an exemplary structure for expanded version of an Envelope (Event Download—Channel Status) message. A result information element can be optionally included and indicate any error type that is due to a data link failure that occurs during an active and/or background BIP session. Exemplary result field values include those that specific a permanent error type reason and/or a temporary error type reason. In some embodiments, a backoff timer value can be included to indicate a time period for when a temporary error can apply. In some embodiments, backoff timer values can be specified as previously discussed regarding FIGS. 4D and 4E. In some embodiments, a result value can be encoded in a channel status message.

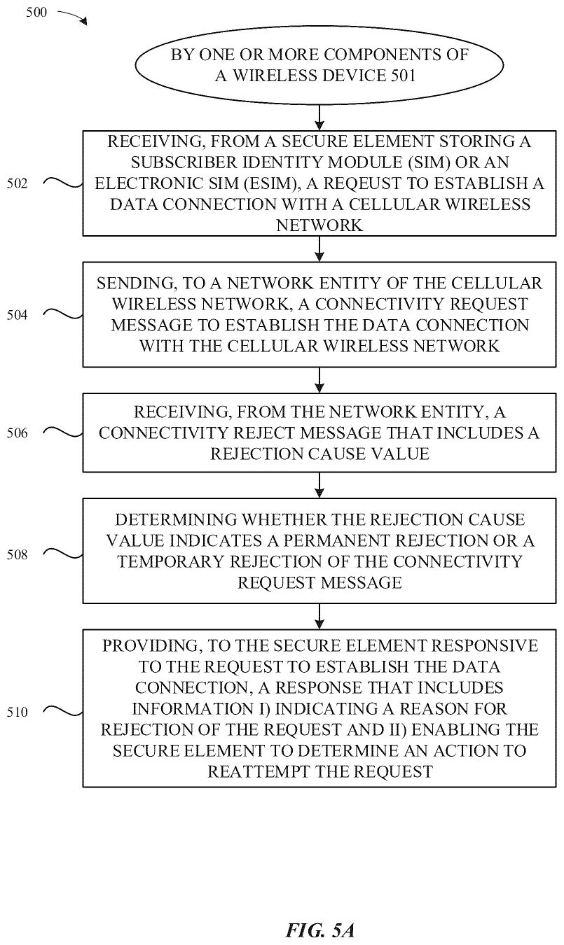

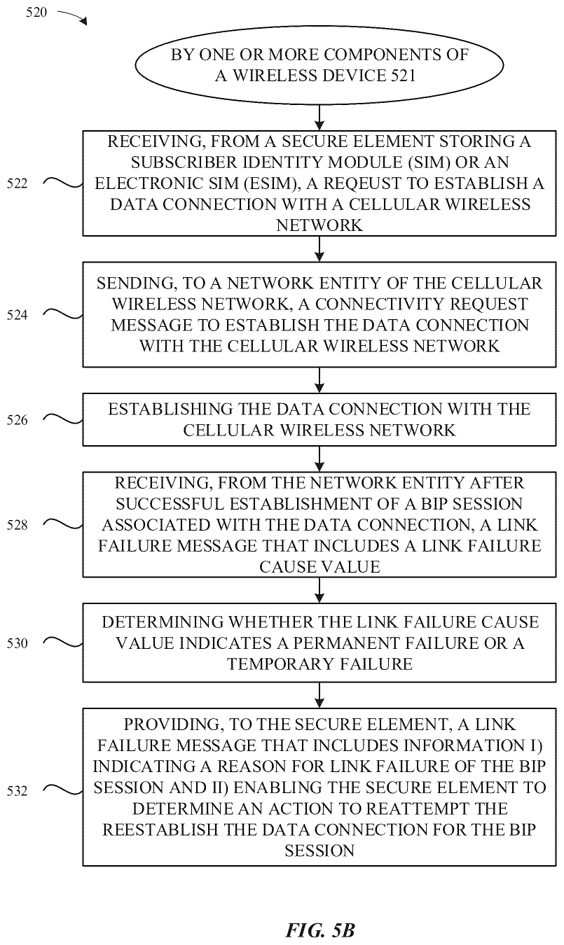

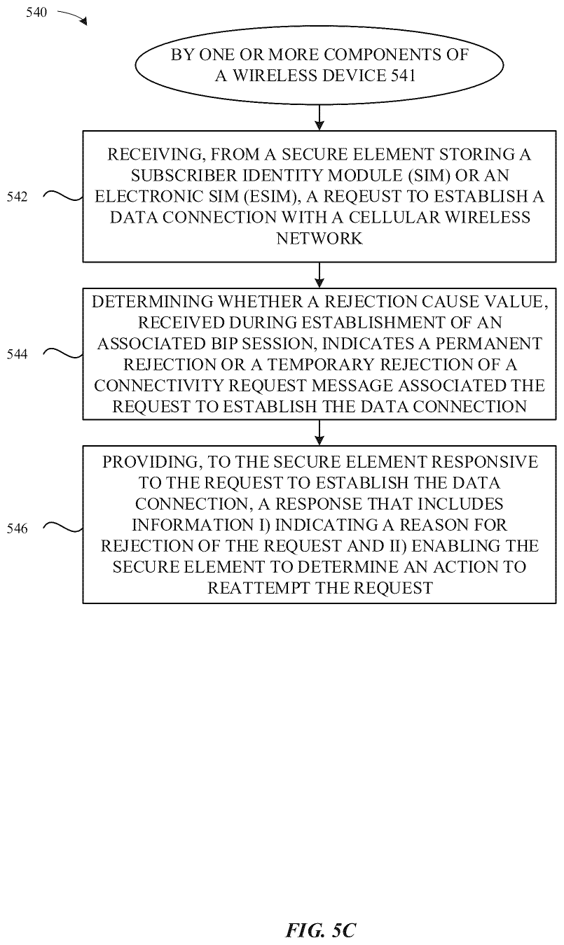

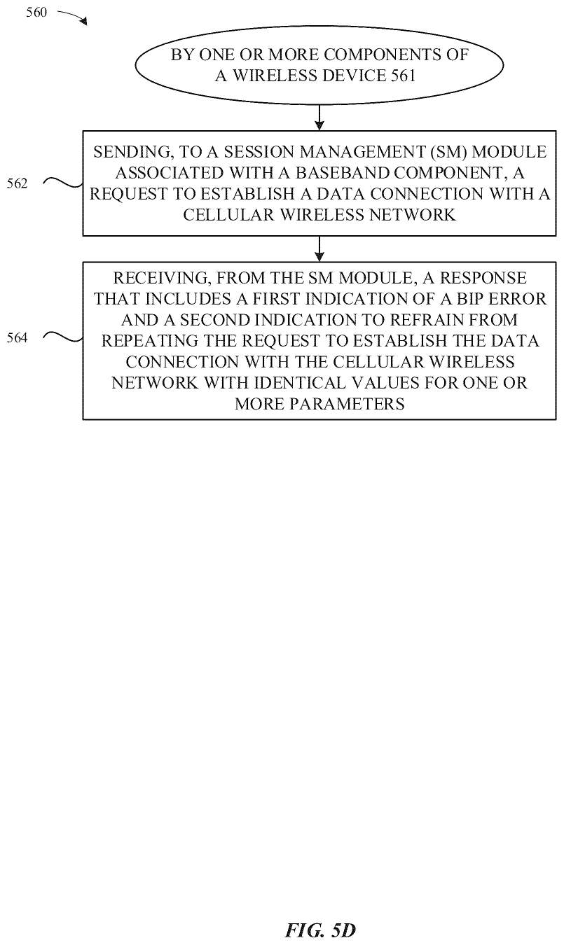

FIG. 5A illustrates a flow chart 500 of an exemplary method, performed by one or more components of a wireless device 501, to manage BIP messaging to accommodate protocol failures. An exemplary embodiment of wireless device 501 can be wireless device 102, wireless device 410, and/or one or more components of the wireless device 102 (e.g., processor(s) 104, memory 106, baseband component(s) 110, eUICC 108, UICC 118, etc.) or of the wireless device 410 (e.g., applications processor 302, baseband component 110, session management (SM) module 304, BIP module 306, eUICC 108, etc.) At 502, the method includes receiving, from a secure element storing a subscriber identity module (SIM) or an eSIM 208, a request to establish a data connection with a cellular wireless network. In some embodiments, the secure element includes a hardware component storing a SIM, eSIM 208, or iSIM, such as a UICC 118 or an eUICC 108. At 504, the method includes sending, to a network entity of the cellular wireless network a connectivity request message to establish the data connection with the cellular wireless network. At 506, the method includes receiving, from the network entity, a connectivity reject message that includes a rejection cause value. At 508, the method includes determining whether the rejection cause value indicates a permanent rejection or a temporary rejection of the connectivity request message. At 510, the method includes providing, to the secure element responsive to the request to establish the data connection, a response that includes information: i) indicating a reason for rejection of the request, and ii) enabling the secure element to determine an action to reattempt the request.

In some embodiments, the response to the secure element includes a first indication of a BIP error. In some embodiments, the response to the secure element further includes a second indication of whether the BIP error is a permanent error or a temporary error. In some embodiments, the response indicates a permanent BIP error, and the secure element is configured to refrain from repeating the request to establish the data connection with the cellular wireless network with identical values for one or more parameters until occurrence of a re-initialization of the secure element. In some embodiments, re-initialization of the secure element occurs in association with, e.g., responsive to reception of, a REFRESH command, a RESET command, or a similar command from a processor of the wireless device. In some embodiments, the one or more parameters include an access point name (APN) value and an Internet Protocol (IP) address type. In some embodiments, the response indicates a temporary BIP error and backoff timer information, and the secure element is configured to refrain from repeating the request to establish the data connection with the cellular wireless network with one or more identical parameters until expiration of a backoff timer. In some embodiments, the backoff timer information includes a time duration value. In some embodiments, the backoff timer information includes a time stamp value. In some embodiments, the response to the secure element includes an indication that only an Internet Protocol (IP) address type version 4(IPv 4 ) or only an IP address type version 6 (IPv6) must be used for an access point name (APN) specified in the request. In some embodiments, the response to the secure element includes an indication that an Internet Protocol (IP) address type version 6 (IPv6) is disallowed for an access point name (APN) specified in the request. In some embodiments, the request to establish a data connection includes an OPEN CHANNEL request message that includes an access point name (APN) and an Internet Protocol (IP) address type. In some embodiments, the response to the request includes an OPEN CHANNEL response message. In some embodiments, a universal SIM (USIM) Service Table elementary file (EF_UST) included in the secure element may indicate to processing circuitry of the wireless device, e.g., a Terminal (ME) component/module, that the secure element supports handling of additional information as discussed hereinabove, e.g., a cause code and/or an associated indications of a backoff timer value, that may be provided in a TERMINAL RESPONSE message. In some embodiments, the processing circuitry of the wireless device, e.g., the Terminal (ME) may enable use of the additional information (cause code, backoff timer value, etc.) based on an indication from the secure element that the additional information feature, as discussed herein, is supported by the secure element.

FIG. 5B illustrates a flow chart 520 of another exemplary method, performed by one or more components of a wireless device 521, to manage BIP messaging to accommodate protocol failures. An exemplary embodiment of wireless device 521 can be wireless device 102, wireless device 410, and/or one or more components of the wireless device 102 (e.g., processor(s) 104, memory 106, baseband component(s) 110, eUICC 108, UICC 118, etc.) or of the wireless device 410 (e.g., applications processor 302, baseband component 110, session management (SM) module 304, BIP module 306, eUICC 108, etc.) At 522, the method includes receiving, from a secure element storing a subscriber identity module (SIM) or an eSIM 208, a request to establish a data connection with a cellular wireless network. In some embodiments, the secure element includes a hardware component storing a SIM, eSIM 208, or iSIM, such as a UICC 118 or an eUICC 108. At 524, the method includes sending, to a network entity of the cellular wireless network a connectivity request message to establish the data connection with the cellular wireless network. At 526, the method includes establishing the data connection with the cellular wireless network. At 528, the method includes receiving, from the network entity after successful establishment of a BIP session associated with the data connection, a link failure message that includes a link failure cause value. At 530, the method includes determining whether the link failure cause value indicates a permanent failure or a temporary failure. At 532, the method includes providing, to the secure element, a link failure message that includes information: i) indicating a reason for link failure of the BIP session, and ii) enabling the secure element to determine an action to reestablish the data connection for the BIP session.

FIG. 5C illustrates a flow chart 540 of a further exemplary method, performed by one or more components of a wireless device 541, to manage BIP messaging to accommodate protocol failures. An exemplary embodiment of wireless device 541 can be wireless device 102, wireless device 410, and/or one or more components of the wireless device 102 (e.g., processor(s) 104, memory 106, baseband component(s) 110, eUICC 108, UICC 118, etc.) or of the wireless device 410 (e.g., applications processor 302, baseband component 110, session management (SM) module 304, BIP module 306, eUICC 108, etc.) At 542, the method includes receiving, from a secure element storing a subscriber identity module (SIM) or an eSIM 208, a request to establish a data connection with a cellular wireless network. In some embodiments, the secure element includes a hardware component storing a SIM, eSIM 208, or iSIM, such as a UICC 118 or an eUICC 108. At 544, the method includes determining whether a rejection cause value, received during establishment of an associated BIP session, indicates a permanent rejection or a temporary rejection of a connectivity request message associated with the request to establish the data connection. At 546, the method further includes providing, to the secure element responsive to the request to establish the data connection, a response that includes information i) indicating a reason for rejection of the request and ii) enabling the secure element to determine an action to reattempt the request.

In some embodiments, the information indicating the reason for rejection of the request includes a first indication of a BIP error. In some embodiments, the information indicating the reason for rejection of the request includes a second indication of whether a BIP error is a permanent error or a temporary error. In some embodiments, the information indicates a permanent BIP error, and the information enabling the secure element to determine an action to reattempt the request further includes information prompting the secure element to refrain from repeating the request to establish the data connection with the cellular wireless network with identical values for one or more parameters until occurrence of a re-initialization of the secure element. In some embodiments, the one or more parameters include an APN value and an IP address type. In some embodiments, the information indicates a temporary BIP error and backoff timer information, and the information enabling the secure element to determine an action to reattempt the request further includes information prompting the secure element to refrain from repeating the request to establish the data connection with the cellular wireless network with one or more identical parameters until expiration of a backoff timer. In some embodiments, the backoff timer information includes a time duration value. In some embodiments, the backoff timer information includes a time stamp value. In some embodiments, the information indicating the reason for rejection of the request includes an indication that only an IPv4 address value or only an IPv6 address value must be used for an APN specified in the request. In some embodiments, the information indicating the reason for rejection of the request includes an indication that an IPv6 address value is disallowed for an APN specified in the request. In some embodiments, the request to establish the data connection includes an OPEN CHANNEL request message that includes an APN and an IP address type. In some embodiments, the response to the request to establish the data connection includes an OPEN CHANNEL response message.

FIG. 5D illustrates a flow chart 560 of an additional exemplary method, performed by one or more components of a wireless device 561, to manage BIP messaging to accommodate protocol failures. An exemplary embodiment of wireless device 561 can be wireless device 102, wireless device 410, and/or one or more components of the wireless device 102 (e.g., processor(s) 104, memory 106, baseband component(s) 110, eUICC 108, UICC 118, etc.) or of the wireless device 410 (e.g., applications processor 302, baseband component 110, session management (SM) module 304, BIP module 306, eUICC 108, etc.) At 562, the method includes sending, to an SM module 304 associated with a baseband component 110, a request to establish a data connection with a cellular wireless network. At 564, the method includes receiving, from the SM module 304, a response that includes a first indication of a BIP error and a second indication to refrain from repeating the request to establish the data connection with the cellular wireless network with identical values for one or more parameters.

### Representative Exemplary Apparatus

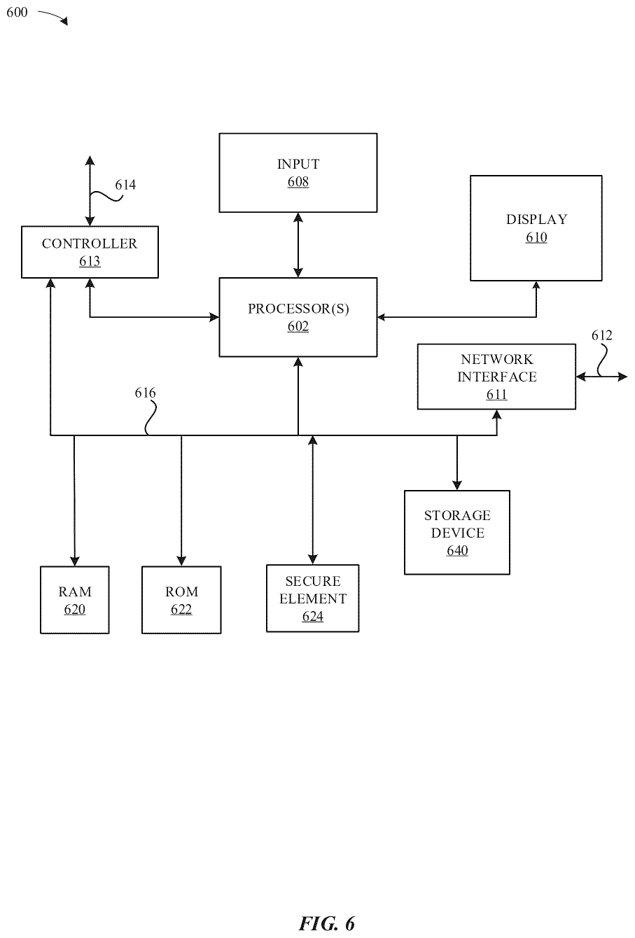

FIG. 6 illustrates in block diagram format an exemplary computing device 600 that can be used to implement the various components and techniques described herein, according to some embodiments. In particular, the detailed view of the exemplary computing device 600 illustrates various components that can be included in the wireless device 102. As shown in FIG. 10, the computing device 600 can include one or more processors 602 that represent microprocessors or controllers for controlling the overall operation of computing device 600. In some embodiments, the computing device 600 can also include a user input device 608 that allows a user of the computing device 600 to interact with the computing device 600. For example, in some embodiments, the user input device 608 can take a variety of forms, such as a button, keypad, dial, touch screen, audio input interface, visual/image capture input interface, input in the form of sensor data, etc. In some embodiments, the computing device 600 can include a display 610 (screen display) that can be controlled by the processor(s) 602 to display information to the user (for example, information relating to incoming, outgoing, or active communication sessions). A data bus 616 can facilitate data transfer between at least a storage device 640, the processor(s) 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include wireless circuitry, such as a wireless transceiver and/or baseband component. The computing device 600 can also include a secure element 624. The secure element 624 can include an eUICC 108, an iUICC, and/or one or more UICCs 118.

The computing device 600 also includes a storage device 640, which can include a single storage or a plurality of storages (e.g., hard drives and/or solid-state drives), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to manage bearer independent protocol (BIP) messaging to accommodate protocol failures, the method comprising:
by one or more components of a wireless device:
receiving, from a secure element storing a subscriber identity module (SIM) or an electronic SIM (eSIM), a request to establish a data connection with a cellular wireless network;
determining whether a rejection cause value, received during establishment of an associated BIP session, indicates a permanent rejection or a temporary rejection of a connectivity request message to establish the data connection; and
providing, to the secure element responsive to the request to establish the data connection, a response that comprises information i) indicating a reason for rejection of the request and ii) enabling the secure element to determine an action to reattempt the request.

2. The method of claim 1, wherein the information indicating the reason for rejection of the request comprises a first indication of a BIP error.

3. The method of claim 1, wherein the information indicating the reason for rejection of the request comprises a second indication of whether a BIP error is a permanent error or a temporary error.

4. The method of claim 3, wherein the information indicates a permanent BIP error, and
wherein the information enabling the secure element to determine an action to reattempt the request further comprises information prompting the secure element to refrain from repeating the request to establish the data connection with the cellular wireless network with identical values for one or more parameters until occurrence of a re-initialization of the secure element.

5. The method of claim 4, wherein the one or more parameters comprise an access point name (APN) value and an Internet Protocol (IP) address type.

6. The method of claim 3, wherein the information indicates a temporary BIP error and
backoff timer information, and
wherein the information enabling the secure element to determine an action to reattempt the request further comprises information prompting the secure element to refrain from repeating the request to establish the data connection with the cellular wireless network with one or more identical parameters until expiration of a backoff timer.

7. The method of claim 6, wherein the backoff timer information comprises a time duration value.

8. The method of claim 6, wherein the backoff timer information comprises a time stamp value.

9. The method of claim 1, wherein the information indicating the reason for rejection of the request comprises an indication that only an Internet Protocol (IP) address type version 4(IPv 4 ) or only an IP address type version 6 (IPv6) must be used for an access point name (APN) specified in the request.

10. The method of claim 1, wherein the information indicating the reason for rejection of the request comprises an indication that an Internet Protocol (IP) address type version 6 (IPv6) is disallowed for an access point name (APN) specified in the request.

11. The method of claim 1, wherein the request to establish the data connection comprises an OPEN CHANNEL request message that includes an access point name (APN) and an Internet Protocol (IP) address type.

12. The method of claim 11, wherein the response to the request to establish the data connection comprises an OPEN CHANNEL response message.

13. An apparatus comprising memory coupled to processing circuitry, the processing circuitry configured to:
receive, from a secure element storing a subscriber identity module (SIM) or an electronic SIM (eSIM), a request to establish a data connection with a cellular wireless network;
determine whether a rejection cause value, received during establishment of an associated bearer independent protocol (BIP) session, indicates a permanent rejection or a temporary rejection of a connectivity request message associated with the request to establish the data connection; and
provide, to the secure element responsive to the request to establish the data connection, a response that comprises information i) indicating a reason for rejection of the request and ii) enabling the secure element to determine an action to reattempt the request.

14. The apparatus of claim 13, wherein the information indicating the reason for rejection of the request comprises:
a first indication of a BIP error; and
a second indication of whether the BIP error is a permanent error or a temporary error.

15. The apparatus of claim 14, wherein the information indicates a permanent BIP error,
wherein the information enabling the secure element to determine an action to reattempt the request further comprises information prompting the secure element to refrain from repeating the request to establish the data connection with the cellular wireless network with identical values for one or more parameters until occurrence of a re-initialization of the secure element, and
wherein the one or more parameters comprise an access point name (APN) value and an Internet Protocol (IP) address type.

16. The apparatus of claim 14, wherein the information indicates a temporary BIP error and
backoff timer information, and
wherein the information enabling the secure element to determine an action to reattempt the request further comprises information prompting the secure element refrain from repeating the request to establish the data connection with the cellular wireless network with one or more identical parameters until expiration of a backoff timer.

17. The apparatus of claim 13, wherein the information indicating the reason for rejection of the request comprises an indication that only an Internet Protocol (IP) address type version 4 (IPv4) or only an IP address type version 6 (IPv6) must be used for an access point name (APN) specified in the request.

18. The apparatus of claim 13, wherein the information indicating the reason for rejection of the request comprises an indication that an Internet Protocol (IP) address type version 6 (IPv6) is disallowed for an access point name (APN) specified in the request.

19. The apparatus of claim 13, wherein:
the request to establish the data connection comprises an OPEN CHANNEL request message that comprises an access point name (APN) and an Internet Protocol (IP) address type; and
the response to the request to establish the data connection comprises an OPEN CHANNEL response message.

20. A method to manage bearer independent protocol (BIP) messaging to accommodate protocol failures, the method comprising:
by one or more components of a wireless device:
sending, to a session management (SM) module associated with a baseband component, a request to establish a data connection with a cellular wireless network; and
receiving, from the SM module, a response that comprises a first indication of a BIP error and a second indication to refrain from repeating the request to establish the data connection with the cellular wireless network with identical values for one or more parameters.
